(19) United States
(12) Patent Application Publication
(10) Pub. No.: US 2021/0256440 A1
(43) Pub. Date: Aug. 19, 2021

(54) SYSTEM AND METHOD FOR GENERATING FOOD MANAGEMENT CALENDAR EVENTS FROM A POINT-OF-SALE TERMINAL

(71) Applicant: Toshiba TEC Kabushiki Kaisha, Shinagawa-ku (JP)

(72) Inventors: Christopher NGUYEN, Huntington Beach, CA (US); William SU, Riverside, CA (US); Jia ZHANG, Irvine, CA (US)

(21) Appl. No.: 16/792,412

(22) Filed: Feb. 17, 2020

(51) Int. Cl. G06Q 10/06; G06Q 10/08; G06Q 30/06; G06T 7/00

(52) U.S. Cl. CPC G06Q 10/06314; G06Q 10/087; G06T 2207/30128; G06T 7/0004; G06Q 30/0627

(57) ABSTRACT

A system and method for consumer food management commences with a consumer identifying themselves to a point-of-sale terminal during checkout for a food purchase. Product information is captured by the point-of-sale terminal by a scanner, digital camera or digital scale. Product life information, when present on a product, is read via optical character recognition. Additional product information is used from barcodes, product lookup codes, product appearance and product packaging. Product information is used, along with current date information, to determine product life dates. These dates are sent to consumer's smartphones or computers as reminders or calendar events which are triggered based on determined product life dates. External links provide suggestions for recipes using food that is at or approaching a determined product life date.

### TECHNICAL FIELD

This application relates generally to monitoring of perishable inventory. The application relates more particularly to determining and remembering food expiration dates during store checkout for end user food inventory management and consumption.

### BACKGROUND

Food purchases are major, ongoing expenditures by all consumers. All food has a finite shelf life. Typically, food products degrade over time. Products like fruits and vegetables may have a shelf life of a matter of days. Frozen food may last several months. Canned food may last several years. It is advantageous to both food suppliers and consumers that food be consumed while it is still safe. Governmental agencies, such as the United States Department of Agriculture (USDA) provide guidance and regulations for labeling dating of food products. In the United States, food product dating is currently only required for infant formula, but the practice is widely used. The U.S. Food Safety and Inspection Service (FSIS) has issued guidelines for food dating. To comply, a product must be labeled with a calendar date expressing both a month and day of the month. In the case of shelf-stable and frozen products, the year must also be displayed. Additionally, immediately adjacent to the date must be a phrase explaining the meaning of that date such as “Best if Used By.”

Manufacturers provide dating to help consumers and retailers decide when food is of best quality. Factors including the length of time and the temperature at which a food is held during distribution and offered for sale, the characteristics of the food, and the type of packaging will affect how long a product will be of optimum quality. Manufacturers and retailers will consider these factors when determining the date for which the product will be of best quality.

For example, sausage is formulated with certain ingredients used to preserve the quality of the product and fresh beef is packaged in a modified atmosphere packaging system that helps ensure that the product will stay fresh for as long as possible. These products will typically maintain product quality for a longer period of time because of how the products are formulated or packaged.

The quality of perishable products may deteriorate after the date passes; however, such products should still be safe if handled properly. Consumers must evaluate the quality of the product prior to its consumption to determine if the product shows signs of spoilage.

Open dating is found on most foods including meat, poultry, egg and dairy products. “Closed or coded dates” are a series of letters and/or numbers and typically appear on shelf-stable products such as cans and boxes of food.

There are no uniform or universally accepted descriptions used on food labels for open dating in the United States. As a result, there are a wide variety of phrases used on labels to describe quality dates. Examples include:
A “Best if Used By/Before” date indicates when a product will be of best flavor or quality. It is not a purchase or safety date.
A “Sell-By” date tells the store how long to display the product for sale for inventory management. It is not a safety date.
A “Use-By” date is the last date recommended for the use of the product while at peak quality. It is not a safety date except for when used on infant formula as noted above.
A “Freeze-By” date indicates when a product should be frozen to maintain peak quality. It is not a purchase or safety date.

The USDA estimates that 30 percent of the food supply is lost or wasted at the retail and consumer levels. One source of food waste arises from consumers or retailers throwing away wholesome food because of confusion about the meaning of dates displayed on the label. To reduce consumer confusion and wasted food, FSIS recommends that food manufacturers and retailers that apply product dating use a “Best if Used By” date. Research shows that this phrase conveys to consumers that the product will be of best quality if used by the calendar date shown. Foods not exhibiting signs of spoilage should be wholesome and may be sold, purchased, donated and consumed beyond the labeled “Best if Used By” date.

With an exception of infant formula as noted above, if the date passes during home storage, a product should still be safe and wholesome if handled properly until the time spoilage is evident. Spoiled foods will develop an off odor, flavor or texture due to naturally occurring spoilage bacteria. If a food has developed such spoilage characteristics, it should not be eaten.

Microorganisms such as molds, yeasts, and bacteria can multiply and cause food to spoil. Viruses are not capable of growing in food and do not cause spoilage. There are two types of bacteria that can be found on food: pathogenic bacteria, which cause foodborne illness, and spoilage bacteria, which do not cause illness but do cause foods to deteriorate and develop unpleasant characteristics such as an undesirable taste or odor making the food not wholesome. When spoilage bacteria have nutrients, moisture, time, and favorable temperatures, these conditions will allow the bacteria to grow rapidly and affect the quality of the food. Food spoilage can occur much faster if food is not stored or handled properly. A change in the color of meat or poultry is not necessarily, but could be, an indicator of spoilage.

### BRIEF DESCRIPTION OF THE DRAWINGS

Various embodiments will become better understood with regard to the following description, appended claims and accompanying drawings wherein:

FIG. 1 is an example embodiment of a system for generating food management calendar events;

FIG. 2 is an example embodiment of a food date notification system;

FIG. 3 is an example embodiment of a digital device system;

FIG. 4 is a block diagram of an example embodiment of a system for generating food management calendar events;

FIG. 5 is an example embodiment of a user notification screen;

FIG. 6 a flowchart of an example embodiment of a system for generating food management calendar events; and

FIG. 7 is a flow diagram of an example embodiment of a system for generating food management calendar events.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

In example embodiments herein, a burden on consumers to track food dates and date types is alleviated by employing a point-of-sale (POS) system, such as those currently available on the market and commonly used at retail checkout counters. A POS system includes an embedded computer, and includes a user interface, such user input and a display, which may be comprised of a touchscreen. A typical POS system in use at a food outlet may include a scanner, such as a barcode scanner, as well as a scale. As detailed below, a POS system determines information about food at the time of purchase and emails a consumer electronic appointments or calendar entries, such as those in commonly used formats including Apple's iCalendar ICS files and Microsoft Outlook vCalendar VCS files which contains all of the information of the food at time of purchase.

When a consumer goes to a checkout counter, they can identify themselves with their purchase transaction in one of several ways. A consumer may scan a loyalty card that can associate an email or text address with their purchases. They may also scan a payment card which can also identify the consumer. Alternatively, the consumer may enter their address information directly into the POS terminal. Consumers can also be identified biometrically, such as with fingerprint, voice, retina or face recognition.

Prior to generating the ICS and VCS files, at time of scanning, the POS system captures one or more images or scans of a food product. An OCR engine determines a food date stamp from the images. Using an artificial intelligence (AI) module, the OCR engine determines which series of numbers and text strings in the image are considered the food date stamp, which then gets converted to metadata for the ICS or VCS files.

For food products that does not have a food date stamp, the POS system combines machine learning (ML) with a recommendation engine to provide a recommended food date that is used in the ICS and VCS files. The ML module incorporates a series of data points such as purchase time, seasonality of the food, and required optimal storage in order to create the recommended food date stamp. The ML module also employs additional visual indicators of food age as detailed below. Resulting metadata is added to the ICS and VCS files. In a particular example embodiment, the recommendation engine also includes metadata of recommended recipes that incorporates one or purchased food items as ingredient. The recommendation engine uses the ML module to tailor and update the recipe recommendations for the consumer. Using data from a food date stamp, the system provides and dynamically updates recipes.

During checkout, the POS system outputs calendar or reminder information and sends them to the consumer, such as to their email address or as a text message. The reminder information includes metadata of relevant food date types by color coded categorizations, URL links to each food product, and alarm notifications. When the consumer opens, for example, their email, the ICS or VCS files automatically get imported to their default calendar application on their device, such as a smartphone, tablet notebook or desktop computer. If their calendar application does not provide automatic acceptance, the consumer may manually import the files into the calendar application.

Food products are displayed in the user's calendar and are suitably color coded for each date type so that the consumer can quickly determine relative time limits. For example, red may indicate expired dates, and yellow indicating a best used date. Alarm notifications can provide the consumer with feedback before a food should be thrown away. In addition, to assist the consumer on using the food products before thrown away, each food event is suitably linked with recipes, such as with URLs directing the user to a list of recommended recipes that incorporates expiring foods as an ingredient.

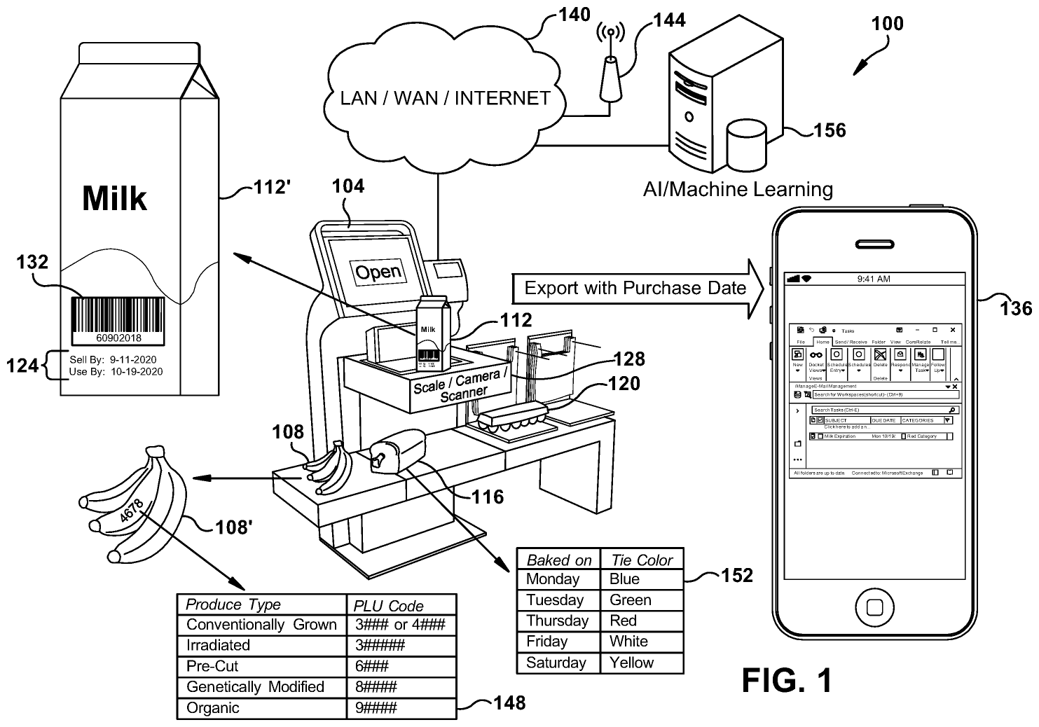

In accordance with the subject application, FIG. 1 illustrates an example embodiment of a system for generating food management calendar events 100 that includes POS terminal 104. POS terminal 104 is illustrated as a self-server checkout counter, however it is to be appreciated than any suitable POS type may be used. In the illustrated example, food for purchase includes bananas 108, milk 112, bread 116 and eggs 120. It is understood that any suitable food item may be included, such as canned goods, goods in jars, bottled goods or frozen goods. In the example embodiment of FIG. 1, milk 112, enlarged at 112′, includes character information 124 that includes a “Sell By” date and a “Use By” date. It is understood that any suitable labeling, as noted above, may accompany date information. POS terminal 104 includes product input 128, suitably comprised of a scanner, such as a barcode scanner, a digital camera and a scale. Character information 124 is imaged by product input 128, and provided with optical character recognition (OCR) to determine the text and date information. Information as to the product type is suitably obtained by a scan of a linear or multidimensional barcode, such as barcode 132. Resultant information, including a purchase date, product life date information, item identification information, and the like, is assembled by POS terminal 104, added to an ICS or VCS file, and communicated to a user device 136. User device 136 is illustrated as a smartphone, but is suitably any user digital device, including a tablet computer, desktop computer, notebook computer, smartwatch, or the like. Data communication between POS terminal 104 and smartphone 136 is via any suitable networked or direct data connection, wireless or wired data connection, such as via network cloud 140 and Wi-Fi hotspot 144. Network cloud 140 is suitably comprised of a local area network (LAN), a wide area network (WAN) which may comprise the Internet, or any suitable combination.

Some food items will not include barcode information or any product life date information. In the example of FIG. 1, this is illustrated by bananas 108. Produce, such as fresh fruits or vegetables, frequently bears indicia referred to as a product lookup (PLU) code. Bananas 108, as enlarged at 108′, includes PLU code 4678, which is an industry standard code for bananas. In a typical POS environment, this code would be entered into the POS terminal during checkout to identify and price the product. This may be incorporated with a food weight as determined by a scale of product input 128. PLU code information allows the POS terminal to identify the food type and determine a likely expiration date in accordance with previously determined shelf life information associated with fresh bananas as well as the current date of purchase. Bananas can have varying shelf life depending on their purchase state and environmental condition. For example, yellow bananas may be purchased with varying levels of green, meaning that they have yet to fully ripen. A captured image of the bananas will allow for adjustment of a determined shelf life in accordance with coloration. Additional information, such as ambient temperature, which may be influenced by a time of year, can affect banana shelf life and is suitably integrated into calculation of life date information. Table 148 illustrates some general guidelines for PLU codes. A PLU code's numeric prefix can identify a produce state, such as conventional, irradiated, pre-cut, genetically modified or organic. This information may also suitably be used to calculate product life. For example, irradiated foods may have a much longer shelf life than the same food when not irradiated.

The example of FIG. 1 also includes baked goods, illustrated by bread 108, which may have a relatively short lifespan. Bagged loafs of bread frequently include a close tie suitably comprised as a plastic clip or twist tie. A standard in the baking industry is to color code ties. Bread is typically delivered on a five day schedule, avoiding Wednesdays and Sundays. Bread from the remaining days includes a tie color coded to its corresponding day as illustrated by table 152. Such color information, along with identification of the product as bread such as via a barcode scan, along with current date information, allows for accurate prediction of a bread life date, even in situations where no date code is present or locatable on the bread packaging.

Also illustrated in FIG. 1 is server 156, suitably in data communication with one or more POS terminals, such as POS terminal 104. Server 156 includes pre-stored product life information which can be distributed to POS terminals. Such product life information is suitably obtained empirically, or via any suitable artificial intelligence or machine learning platform.

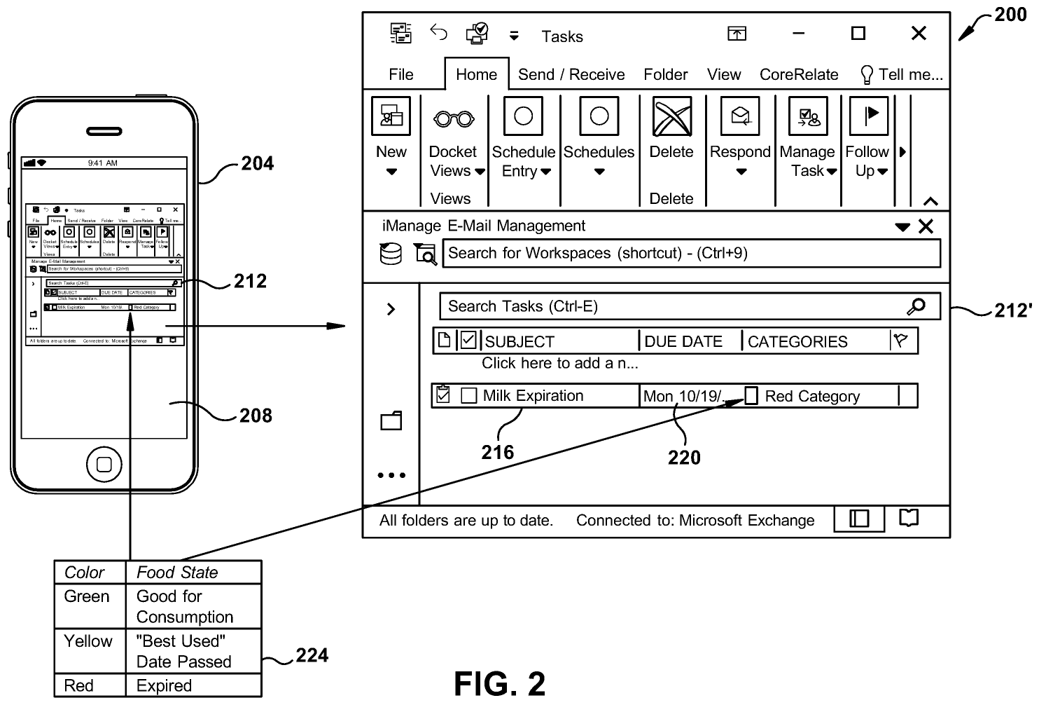

FIG. 2 illustrates an example embodiment of a food date notification system 200 such as may be realized from the system of FIG. 1. Smartphone 204 includes a touchscreen display 208 which shows a reminder entry screen 212, magnified at 212′. In the example, a food item appears as a milk entry 216 showing a product life date 220. Screen 212 is suitably generated from an ICS or VCS file, or any other suitable file format, emanating from a POS. Entry 216 also includes a color tag 220, color coded in accordance with a current food state. As illustrated in table 224, example colors may include green for food good for consumption, yellow for when food is still editable but past a food life date or red for when food is expired and no longer fit for consumption.

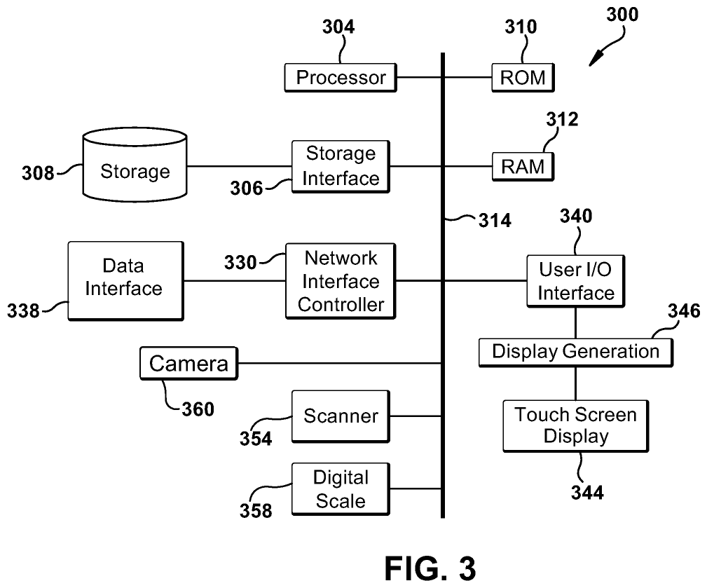

Turning now to FIG. 3, illustrated is an example of a digital device system 300 suitably comprising server POS terminal 104 of FIG. 1, as well as being illustrative of any digital information device, such as smartphones 136, 204 or server 156. Included are one or more processors, such as that illustrated by processor 304. Each processor is suitably associated with non-volatile memory, such as read only memory (ROM) 310 and random access memory (RAM) 312, via a data bus 314.

Processor 304 is also in data communication with a storage interface 306 for reading or writing to a data storage system 308, suitably comprised of a hard disk, optical disk, solid-state disk, or any other suitable data storage as will be appreciated by one of ordinary skill in the art.

Processor 304 is also in data communication with a network interface controller (NIC) 330, which provides a data path to any suitable network or device connection, such as a suitable wireless data connection via wireless network interface 338. A suitable data connection to an MFP or server is via a data network, such as a local area network (LAN), a wide area network (WAN), which may comprise the Internet, or any suitable combination thereof. A digital data connection is also suitably directly with an MFP or server, such as via Bluetooth, optical data transfer, Wi-Fi direct, or the like.

Processor 304 is also in data communication with a user input/output (I/O) interface 340 which provides data communication with user peripherals, such as touch screen display 344 via display generator 346, as well as keyboards, mice, track balls, touch screens, or the like. It will be understood that functional units are suitably comprised of intelligent units, including any suitable hardware or software platform.

Also in data communication with data bus 314 is a digital camera 360, suitably a color camera, as well as scanner 354 which may comprise a barcode scanner, and digital scale 358, all of which suitably comprise product input 128 of FIG. 1.

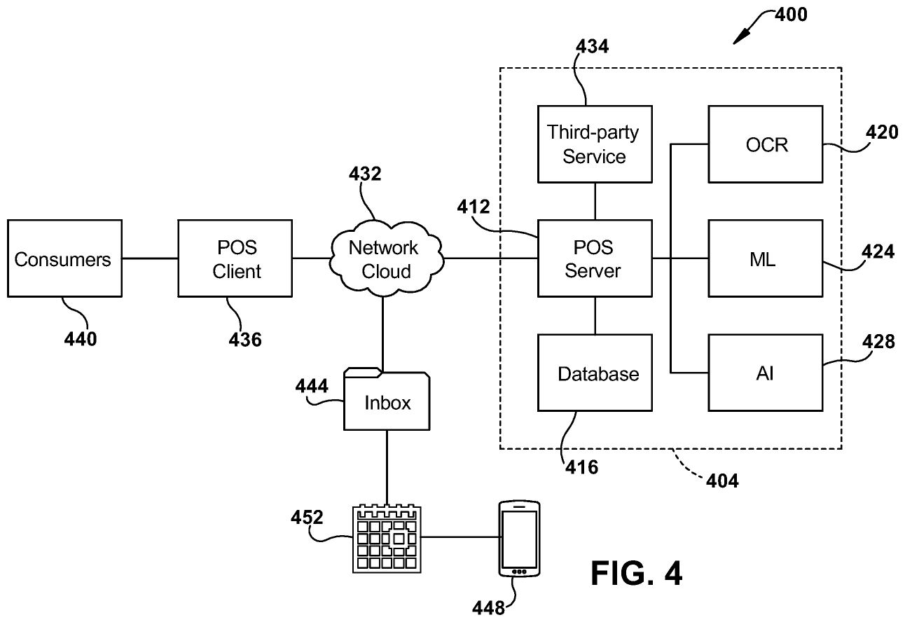

FIG. 4 is a block diagram of an example embodiment of a system for generating food management calendar events 400. Block 404 illustrates supplier side activity to generate content to be communicated to consumers. Included in block 404 is a POS server 412, which is in data communication with food date database 416, suitably locally or on a remote server. POS terminal 412 is also provided with optical character recognition capability at block 420, machine learning capability at block 424 and with artificial intelligence capability at block 428. POS terminal 412 is in data communication with network cloud 432. Third party service 434 may comprise additional network resources, such as web information from a food supplier relative to their products, or other sources with consumer relevant information. Third party service 434 may also include recipe information of interest to consumers relative to their food purchases.

Sales side activity occurs with POS client 436 interacting with consumers 440. The system electronic files relative to purchased food items and sends them to an inbox 444, of smartphone 448, and illustrated by calendar entry 452.

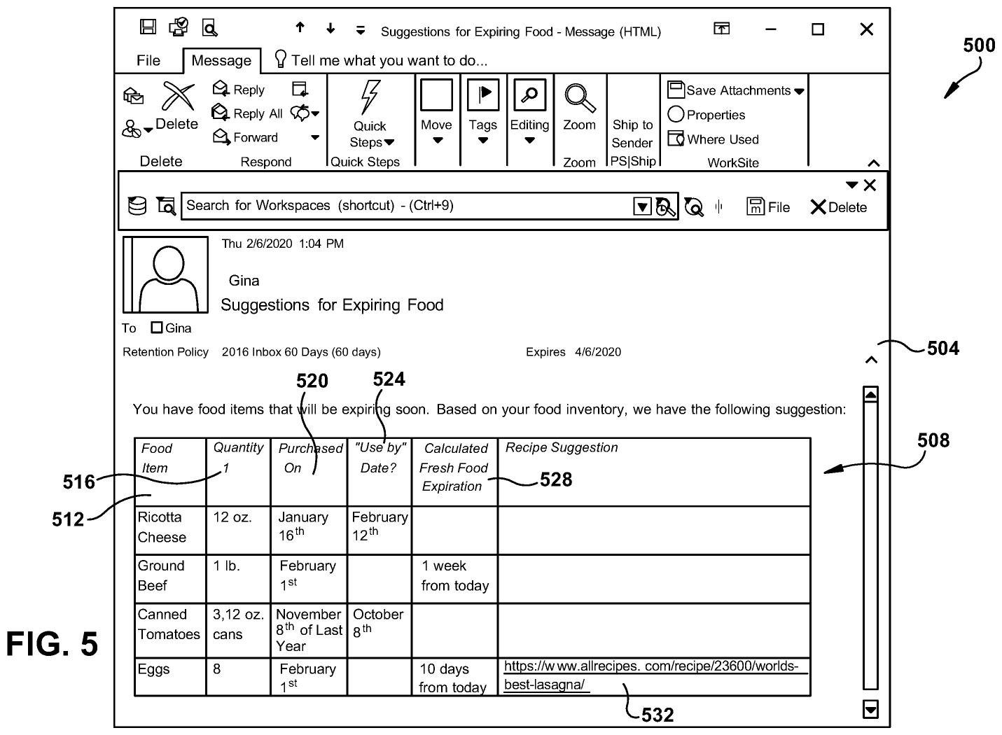

FIG. 5 illustrates a screenshot of an example user notification screen 500 as it may appear on their device. In the example, the notification screen is comprised of an email message to a consumer which includes information 508 relating to their food purchases. In the example, the consumer is provide with food information for food they have purchased including food identification 512, quantity 516, purchase date 520, “use by” date 524 and expiration information 528. In the illustrated example, the system has ascertained food items that are closer to expiration, and searches for and displays a suggest recipe at URL 532 that will allow the consumer to use these items.

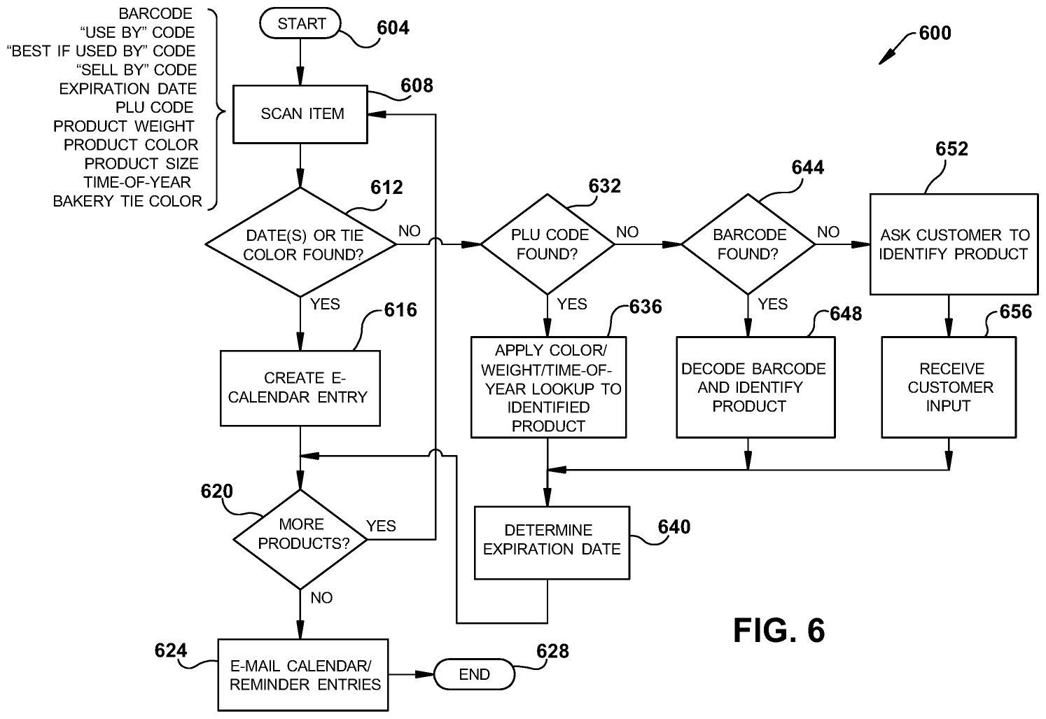

FIG. 6 is a flowchart 600 an example embodiment of a system for generating food management calendar events. The process commences at block 604 and proceeds to block 608 where a food item is scanned, weighed and/or imaged. Indicia from captured product information is tested at block 612 for detected food dates, or in the instance of bread products, there may also be information from a packaging tie color. If found, they are used at block 616 to create an entry, such as a reminder or calendar entry. This can be a single calendar entry, or an entry that is used for multiple items. If it more products exist at block 620, the process returns to block 608 for scanning of another item. If there are no more products, the information is sent to the consumer at block 624, and the process ends at block 628.

If no usable information is found at block 612, the process moves to block 632 and determines if PLU code information is available. If it is, food properties are analyzed at block 636 and date information determined at block 640. The process then returns to block 620. If no PLU code is found at block 632, the process looks for barcode information at block 644. If found, the product is identified at block 648 and a corresponding expiration date determined at block 640. If no barcode is found at block 644, the system may seek customer input to identify the product at block 652, receiving their input at block 656. If user input is usable, an expiration date is determined at block 640. If not, the item may be skipped. The process then returns to block 620.

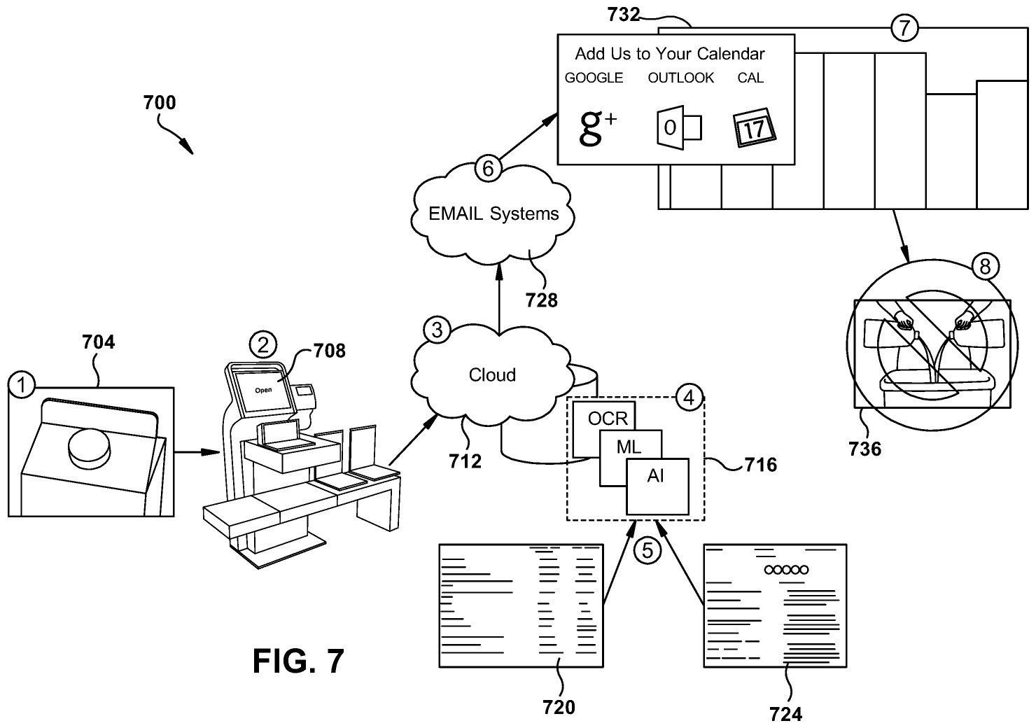

FIG. 7 is a flow diagram 700 of an example embodiment of a system for generating food management calendar events. The flow commences at block 704 when a product is selected, then it is scanned, imaged and/or weighed at block 708. Resulting product information is communicated via cloud 712 to an OCR/Machine Learning/Artificial Intelligence server 716, which includes pre-stored product date information 720, as well as provides access to web resources 724. Email systems 728 relay calendar information 732 to a consumer's device and, in the example, denoted expired food leading for disposal at 736.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A system comprising:
a memory;
a data interface;
a digital camera configured to capture digital image of a food item and store the captured digital image in the memory; and
a processor,
the processor configured to determine a product life date of the food item in accordance with indicia in a captured digital image,
the processor further configured to generate an electronic calendar entry corresponding to the determined product life date, and
the processor further configured to communicate the generated electronic calendar entry to an associated user via the data interface.

2. The system of claim 1 wherein the indicia includes one or more of characters, barcodes or colors associated with the food item.

3. The system of claim 2 wherein the processor is further configure to determine characters in the captured digital image in accordance with optical character recognition.

4. The system of claim 3 wherein the determined characters includes one or more of a printed product life date and a printed product lookup code.

5. The system of claim 4 wherein the processor is further configured to determine the product life date in accordance with a food type identified by the product lookup code.

6. The system of claim 5 wherein the processor is further configured to determine the product life date in accordance with a current date.

7. The system of claim 5 wherein the processor is further configured to determine the product life date in accordance with a color of the food item.

8. The system of claim 2 wherein the processor is further configured determine the product life date in accordance with a decoded barcode.

9. A method comprising:
capturing a digital image of a food item;
determining a product life date of the food item in accordance with indicia in the captured digital image;
generating an electronic calendar entry corresponding to a determined product life date; and
communicating a generated electronic calendar entry to an associated user via the data interface.

10. The method of claim 9 further comprising determining the product life date from indicia including one or more of characters, barcodes and colors associated with the food item.

11. The method of claim 10 further comprising determining characters in the captured image in accordance with optical character recognition.

12. The method of claim 11 further comprising determining the characters from one or more of a printed product life date and a printed product lookup code.

13. The method of claim 12 further comprising determining the product life date in accordance with a food type identified by a product lookup code.

14. The method of claim 13 further comprising determining the product life date in accordance with a current date.

15. The method of claim 13 further comprising determining the product life date in accordance with a color of the food item.

16. The method of claim 10 further comprising determining the product life date in accordance with a decoded barcode.

17. A system comprising:
a digital camera configured to capture a digital image of a food item;
memory configured to store the captured digital image of the food item;
a data interface; and
a processor,
the processor configured to detect barcodes and characters associated with the food item from the captured digital image,
the processor further configured to perform optical character recognition on detected characters,
the processor further configured to determine a product life date of the food item in accordance with recognized optical characters,
the processor further configured to decode detected barcodes,
the processor further configured to determine the product life date of the food item in accordance with a food identified by a decoded barcode,
the processor further configured generate an electronic calendar entry corresponding to the determined product life date, and
the processor further configured to communicate the generated electronic calendar entry to an associated user via the data interface.

18. The system of claim 17 wherein the processor is further configured to determine a product lookup code from recognized optical characters and determine the product life date in accordance with a food identified by a determined product lookup code.

19. The system of claim 18 wherein the processor is further configured to determine the product life date in accordance with a color or weight of the food item.

20. The system of claim 19 wherein the processor is further configured to determine the product life date in accordance with a current date.
